(19) United States
(12) Patent Application Publication
(10) Pub. No.: US 2007/0029164 A1
(43) Pub. Date: Feb. 8, 2007

(54) Device for transporting and/or storing piece goods

(75) Inventor: Jos Van Bree, Westdorpe (NL)

Correspondence Address: SIMPSON & SIMPSON, PLLC, 5555 MAIN STREET, WILLIAMSVILLE, NY, 14221-5406, US

(73) Assignee: Conteyor Multibag Systems N.V., Merelbeke (BE)

(21) Appl. No.: 10/547,048

(22) PCT Filed: Mar. 1, 2004
(86) PCT No.: PCT/EP04/02042

§ 371 Date: Jun. 2, 2006

(30) Foreign Application Priority Data
Feb. 28, 2003 (DE) 103 09 127.0

(51) Int. Cl. B65G 9/00

(52) U.S. Cl. 198/347.1

(57) ABSTRACT

A device for transporting and/or storing piece goods, includes a foldable web (2), which is made of flexible material, e.g. woven material, and which is folded while forming at least one essentially U-shaped holding pouch (1), in which the piece good can be held, and including a suspending device (7), which is situated at the upper end of the pouch (1) and which has at least one supporting bar (6), which can be connected to the upper end of the pouch (1), extends away in a longitudinal direction (X) over the length of the pouch (1), and whose ends are mounted in retaining means fastened to a frame, wherein the at least one supporting bar (6) is provided with apparatus for displaceably guiding the holding pouch (1) in at least two different directions (X, Y), at least a portion of these means being provided at the ends of the supporting bar (6).

### BACKGROUND OF THE INVENTION

The invention relates to a device for transporting and/or storing piece goods, comprising a foldable web, which is made of flexible material, e.g. woven material, and which is folded while forming at least one essentially U-shaped holding pouch, in which the piece good can be held, and comprising a suspending device, which is situated at the upper end of the pouch and which has at least one supporting bar, which can be connected to the upper end of the pouch, extends away in a longitudinal direction over the length of the pouch, and whose ends are mounted in retaining means fastened to a frame.

A device of the aforementioned type is partially known per se. There are thus known, for example, U-shaped holding pouches in which piece goods are transported, particularly piece goods of the same kind, which are required as finished parts or as components or semifinished parts for the production and assembly of more complex objects. An example of these are vehicle body parts in the automobile industry, which are stamped and shaped, for example, in a vehicle body parts factory at a distance from the vehicle assembly factory, and only then have to be transported to the assembly location.

Many piece goods are susceptible to damage, and are therefore transported by means of holding pouches of the type described above. This transportation can be effected in different ways and by means of different systems. Thus, in the case of certain piece goods that are produced for further processing or assembly, the loading and unloading operations must be made as simple and rapid as possible. If possible, it should not be necessary to pack each individual piece in its own container and subsequently remove it again in a time-consuming manner, since this would render the production process, for example of an automobile, substantially more expensive. The very expensive packaging material may also contribute to this increased expense.

The piece goods transported in the holding pouches may vary greatly in form. Known transport devices are used in such a way that, in each case, a series of identical objects is held in the individual, successively arranged pouches, in a frame or container. This, of course, does not preclude, for example, alternately differing objects from also being arranged in the pouches.

As in the case of the prior art, the meaning of the term “frame” used here is to be understood in a wide sense. It includes all types of open and closed stands or frames, including closed boxes or cases, which consist only of side walls and a base and/or cover. In addition, the term “flexible material” is also to be understood in a very wide sense, and comprises films as well as woven fabric, nets and individual strips of film or woven material, or of cords, arranged in parallel next to one another. Known in the art is the practice of suspending such a flexible material from two supporting bars, the material suspended from the two adjacent bars sagging in the form of a loop, while forming the said holding pouch. At the ends, the holding pouch according to the invention may be open or closed. The pouches may also be closable by means of an—optionally elastic—band, so that the two opposing parts of a holding pouch are held together at the ends. The flexible material, i.e. the foldable web, may preferably extend between two adjacent supporting bars. Alternatively, however, the foldable web may also extend over three supporting bars, so that a series of interconnected loops, or a plurality of holding pouches, is formed. The device according to the invention can also be applied to two or three adjacently arranged, U-shaped holding pouches formed in this manner.

If a series of successively arranged holding pouches of the device described at the outset is arranged in a frame having holding means, such as rails, attached thereto, a plurality of frames can be loaded onto a lorry and these can then be transported to the production site. There, the frames have to be taken into the factory and unloaded sequentially, device by device, and supplied to the individual processing stations. In this case, it is simple if the unloading direction is only one single direction and, conversely, following removal of the respective piece good, the station for re-use also lies in a single position, so that the direction of removal is also only one single direction. Owing to the complexity of assembly work, however, it is frequently the case that the transport devices, with the holding pouches, have to be sequentially transported, moved or displaced in different directions. This is not possible with the existing transport devices comprising holding pouches.

There have already been created transport devices having woven-fabric webs, in which a relatively large number of U-shaped holding pouches are created by adjacent loop-type folds. Although it is then possible for a plurality of transport devices to be simultaneously loaded with holding pouches, stored and transported, i.e. to be conveyed in a frame and also removed again from the latter, loading of such a frame with holding pouches from different directions, and also their removal to different directions, is again precluded. This interferes with the flexibility of the transport systems, and therefore also, ultimately, of the interconnection of the various processing stations.

### BRIEF DESCRIPTION OF THE INVENTION

It is therefore the object of the present invention to create a device, of the type stated at the outset, by means of which the holding pouch can be more easily moved and stored by the user of the device.

The device of the invention for transporting and/or storing piece goods, includes a foldable web (2), which is made of flexible material, e.g. woven material, and which is folded while forming at least one essentially U-shaped holding pouch (1), in which the piece good can be held, and including a suspending device (7), which is situated at the upper end of the pouch (1) and which has at least one supporting bar (6), which can be connected to the upper end of the pouch (1), extends away in a longitudinal direction (X) over the length of the pouch (1), and whose ends are mounted in retaining means fastened to a frame, wherein the at least one supporting bar (6) is provided with apparatus for displaceably guiding the holding pouch (1) in at least two different directions (X, Y), at least a portion of these means being provided at the ends of the supporting bar (6).

### BRIEF DESCRIPTION OF THE SEVERAL VIEWS OF THE DRAWINGS

FIG. 1 a perspective view of a transport device according to the invention, with a holding pouch having, arranged at the top, a suspending device of a preferred first version,

FIG. 2 in reduced scale, a side view of the transport device of FIG. 1, as viewed in the transverse direction,

FIG. 3 again in a perspective view, a representation similar to that of FIG. 1, but of a different version, in which only rollers, and no slide hooks, are provided,

FIG. 4 a reduced side view, similar to FIG. 2, in which, however, the slide hooks according to the version according to FIG. 3 have been replaced by transverse rollers,

FIG. 5 is a perspective view similar to those of FIGS. 1 and 3, but of a substantially simplified version having only one supporting bar,

FIG. 6 is again a side view similar to FIGS. 2 and 4, but in this case both according to the version of FIG. 5 and having opposing rails as retaining means, and having an enlargement at only one end of the supporting bar,

FIG. 7 is another version of the transport device, wherein there is provided only one supporting bar, over which there extends a box rail, in which there runs, as an enlargement, a ball which is attached, at the top, to the centre of the supporting bar,

FIG. 8 is a side view, as viewed, for example, from left to right in FIG. 7,

FIG. 9 is a likewise reduced side view similar to FIG. 7, wherein, however, instead of the one ball, two balls arranged at a distance from one another are attached, at the top, to the supporting bar, and run in the box rail,

FIG. 10 is a representation similar to that of FIG. 6, wherein enlargements are shown provided on both ends of the single supporting bar, and only one ball is mounted in the centre, and

FIG. 11 is a further version of the invention, which is intended to facilitate the gripping and carrying of a pouch by hand for the purpose of transferring it from one rail system into another.

### DETAILED DESCRIPTION OF THE INVENTION

This object of the invention is achieved in that the at least one supporting bar is provided with means for displaceably guiding the holding pouch in at least two different directions, at least a portion of these means being provided at the ends of the supporting bar. If one considers a first, namely, the simplest, version of the transport device according to the invention, the holding pouch is created by loop-type folding around only one single supporting bar, a retaining loop being formed, in turn, in the upper region of the holding pouch, by a longitudinal seam, and the one supporting bar being inserted longitudinally through this retaining loop. Adjoining beneath it is the actual holding pouch, which can be loaded from the end. The simplest version is a supporting bar, which is circular in cross-section and which is cut off at its ends to such a length that each end rests on a rail as a retaining means. The holding pouch can thereby be moved in one direction. Preferably, at least one enlargement is then additionally provided as a retaining means, at the top of the supporting bar, for displaceably guiding the holding pouch. The holding pouch can thereby be displaced in any direction.

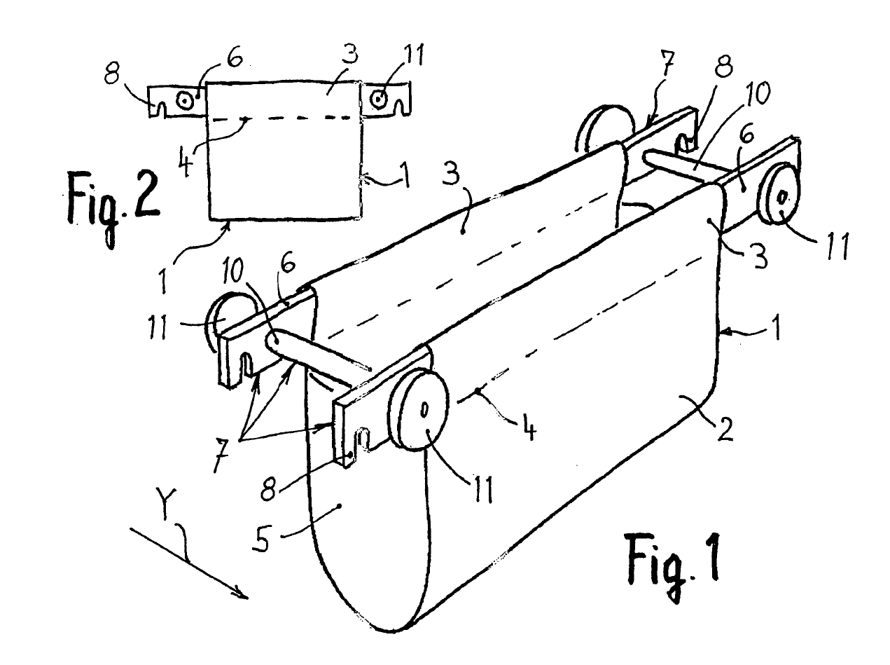

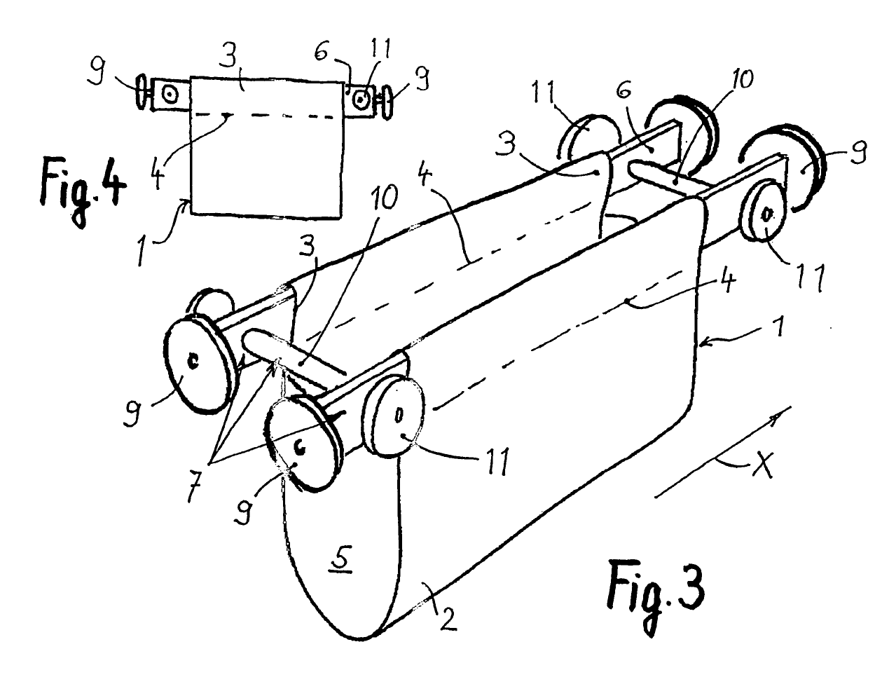

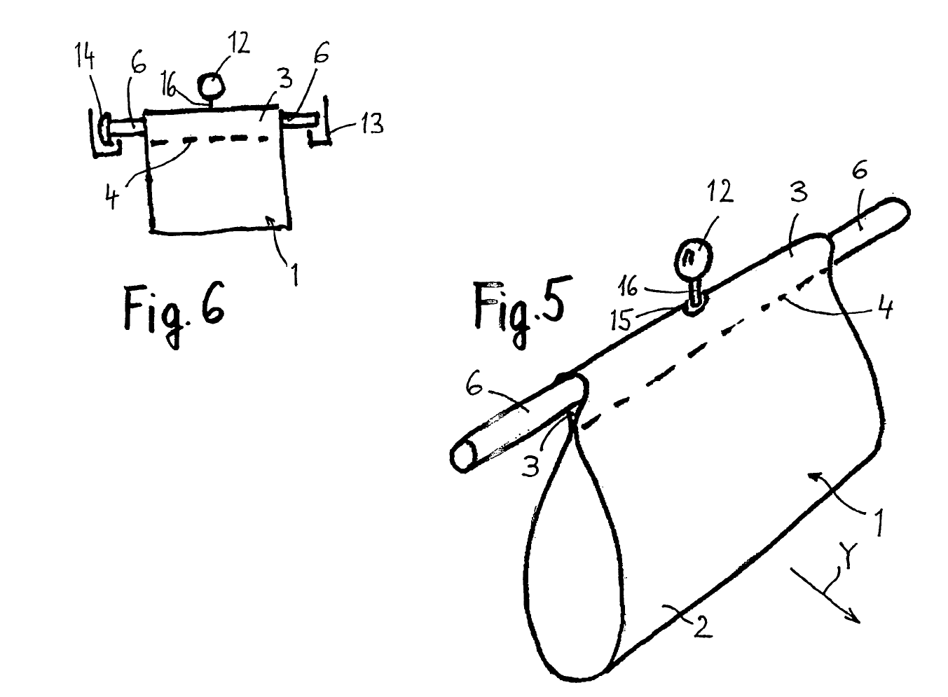

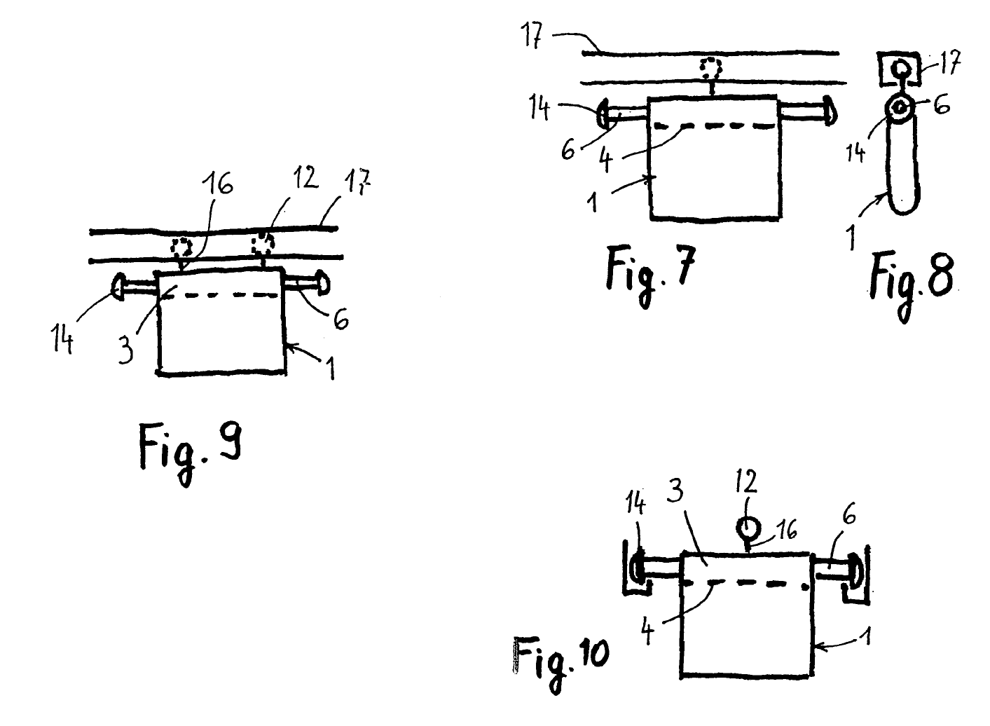

Another version of the invention is characterized in that means are provided, at the ends of the at least one supporting bar, for displaceably guiding the holding pouch in at least two different directions. In this case it is particularly advantageous if, according to the invention, the suspending device has at least two supporting bars. As can be seen in FIGS. 1 and 2, and also in FIGS. 3 and 4, the ends of the supporting bars 6 are either realized as slide hooks 8 or they are provided with transverse rollers 9, while the longitudinal rollers 11 are mounted on the supporting bars, at a certain distance from the ends of the latter.

The user of the device comprising the holding pouch is able to move or displace the latter not merely in one direction, but also in a second or possibly third direction. This means a more convenient manipulation of the holding pouch which, in both the loading and unloading of tracks coming from various directions, can move into downstream or receiving tracks running in a different direction in relation either to the former and/or to itself. In this case, it is of no consequence whether these tracks are rectilinear or curved. What is of importance is that, at the transfer point, a simple holding pouch having a simple suspending device can be easily transferred from a guide or track system. The device according to the invention is preferably to be used in a sequential system in which holding pouches are removed successively from one system and forwarded to another. The “easier” movement can also be understood, inter alia, in respect of the weight. Owing to its simple suspending device, the new transport device can be produced with lightweight materials, so that the total weight may be easily manipulated by the operator.

For reasons of weight, it is preferable to provide the transport device according to the invention with only one U-shaped holding pouch, in order to keep the overall device light and of small in volume. In this case, the holding pouch formed from the foldable web of flexible material is suspended by means of respectively one small retaining loop, through which the supporting bars are inserted longitudinally. In the case of another version, two U-shaped holding pouches could also be arranged adjacently and, through a third supporting bar arranged in parallel and between them, constitute two holding pouches, in the form of two U-shaped loops closed at the bottom, the web being laid in the form of a loop over the middle supporting bar, and thereby being retained by the latter. It is also expedient in this case for the foldable web to be produced from very flexible material, so that the end user can properly store the transport device, and move and manipulate it easily and conveniently. It is understood that the U-shaped pouches need not consist of only a single web but, in particular, may also be composed of a plurality of flexible elements such as, for example, two vertical webs, which are joined at the lower end by a third, transverse web, which is sewn, adhesive-bonded or welded-on. Furthermore, a reinforcing layer may be inserted in the lower region of the pouches, or the base of the pouches may be double-walled, so that a reinforcing layer, e.g. a semi-rigid plastic element, may be inserted, which holds the two vertical suspended side walls of the pouches at a certain distance from one another.

In the case of a preferred version, provision is made, according to the invention, whereby the two displacement directions of the holding pouches are perpendicular to one another. It may well be envisaged that, at the transfer node, an incoming straight track is constituted by, for example, two rails or two bars, running parallel to and at a distance from one another while, on the discharge side, a track constituted by two rails or bars likewise runs off at a distance from and perpendicularly to the first. If one assumes a horizontal plane perpendicular to the vertical, it may then be envisaged that the two rails or bars of the respective track likewise span a plane. This plane need not lie exactly in the horizontal, but this is preferred. The intake side of the track is in this case preferably parallel to the discharge plane of the other track. This is not precluded by the fact that the two tracks are perpendicular to one another.

Furthermore, according to the invention, in the case of another version the distance between the two supporting bars is fixed, and determined by a respective transverse bar arranged in the region of the bar end. The opening of the holding pouch is thereby defined from the top. The transverse bar constitutes part of the suspending device which, like a frame, holds the foldable web open at the top, in the form of a pouch. The transverse bar, however, could also be designed to be telescopically adjustable and then lockable, so that the distance between the two bars is fixed, but can be varied prior to locking. Moreover, it is understood in this case that the holding pouch is at least partially closed at the longitudinal ends (front and back).

The invention is further advantageously designed in that the means for displaceably guiding the holding pouch in a direction have downwardly open slide hooks provided at the end regions of the supporting bars. It has already been mentioned above that the rails are constituted by two intake-side bars or discharge-side bars (or, in the case of another version, rails), which run at a distance from one another. Downwardly open slide hooks are able to slide displaceably on these bars, as in the case of file folders in a suspension filing cabinet. The operator then only has to displace the holding pouch by the desired distance on the bar. This displaceable guiding in the one direction can be described as the Y direction, a direction which runs perpendicularly to the longitudinal extent of the supporting bars.

Since, according to the basic concept of the invention, the holding pouch is provided in two different directions, preferably straight directions, a further version is characterized in that the means for displaceably guiding the holding pouch in a direction, in this case the X direction, have downwardly open slide hooks provided at the end regions of the transverse bars. The one intake-side rail may be constituted by, for example, two parallel bars, and the other, discharge-side rail, then also constituted, in the case of this version, by two bars. The holding pouch can be placed directly onto the discharge-side system from the intake-side system, without the need to turn the holding pouch by the angular amount by which the rails or displacement directions are angled. In the case of these versions, the holding pouch has been moved via bars and, following transfer, it is likewise again moved by displacement on other bars. The downwardly open slide hooks are expedient for this purpose. For the Y direction, the slide hooks are mounted at the ends of the supporting bars, and for the X direction the slide hooks are mounted at the ends of the transverse bars.

Also conceivable, however, is another version which, according to the invention, is characterized in that the means for displaceably guiding the holding pouch in a direction, which may be better envisaged as the X direction, have longitudinal rollers rotatably arranged at the end regions of the transverse bars. A person skilled in the art can very easily realize this instruction of the invention, since the longitudinal rollers rotate about axial pins which can be embedded in the transverse bars. Thus, in the case of this version, for example, movement can be effected in the Y direction by means of slide hooks, and a rolling displacement can be effected in the X direction by means of longitudinal rollers.

It is also advantageous according to the invention if, in the case of another version, the means for displaceably guiding the holding pouch in a direction, which may be more easily envisaged here as the Y direction, have transverse rollers rotatably arranged at the end regions of the supporting bars. The transverse rollers permit the roller-type displacement of the holding pouch in the transverse direction, i.e. preferably perpendicularly to the longitudinal direction, which is also the longitudinal extent of the supporting bars. For this reason, the transverse rollers at the ends of the respective supporting bars provide for displaceable guidance in the Y direction.

It is of course also possible, according to the invention, for the means for displaceably guiding the holding pouch in both directions, which may be better envisaged here by considering both the X and the Y direction, to have downwardly open slide hooks. In this case, there is the possibility, already indicated above, of displacing the holding pouch in both directions X, Y on bars by means of the slide hooks. Analogously, it is furthermore possible, according to the invention, for the means for displaceably guiding the holding pouch in both directions X, Y to be rollers rotatably arranged on the supporting bars and on the transverse bars. According to the invention, the transport device can be displaced in two different directions at different times. Depending on the version described above, the suspending device may have four rollers and four slide hooks, or eight rollers and eight slide hooks.

Instead of rollers, the bars, for example the supporting bars and/or the transverse bars, may each have an enlarged end or a constriction at a short distance from their end, thereby realizing means equivalent to the rollers.

From the preceding description, it should also be evident, in respect of the holding pouches, that the supporting bars support the web material in such a way that the latter forms loops, as holding pouches for the piece goods, between the supporting bars. The supporting bars of the suspending device are retained and preferably displaceably guided by retaining means which are attached to a frame. These are the aforementioned rails or bars, which are mounted on the frame. The term “frame” in this case is to be understood in a very wide sense, and comprises all types of open or closed stands, which may also have side walls and/or a base and/or a cover, and thus constitute closed containers, or also open frames only. Such frames may be provided in production sites, on lorries or at other locations.

Furthermore, it is advantageous, according to the invention if the ends of the supporting bar are supported on or in a rail as a retaining means. In this case, the ends of the supporting bar do not need to be of a special design, or provided with an enlargement or the like. The simplest version of the transport device according to the invention provides only for the insertion of the single supporting bar, with the holding pouch suspended therefrom, into two opposing rails. If this transport device is removed from the rails, and if it is desired to transfer into another retaining means for displacement in another direction, then use is made of the other displacement means, which are mounted at the top, in the manner already described, on the support bar, and which may have an enlargement, for example a ball, which likewise can be introduced into a rail, this rail being able to run in a direction other than that of the first rail.

The invention is further advantageously designed in that the means for displaceably guiding the holding pouch in at least two different directions have slide hooks, rollers, enlargements or the like.

In another preferred version of the invention, at least one transverse bar is mounted between two parallel supporting bars and at a distance from the free ends of these supporting bars, and connects the two supporting bars. Two such transverse bars are expediently arranged at a distance from one another somewhere along the two parallel supporting bars, i.e. they do not necessarily have to be in the end region of the supporting bars, but may also be arranged in a region which is also encompassed by the U-shaped pouch, while the ends of the supporting bars project out beyond the ends of the U-shaped pouch.

Furthermore, there is preferably provided a hinge element which is realized to be rotatably mobile about the transverse bar, as a hinge axle. The hinge element furthermore preferably has a further eyelet, through which there extends an axle on which there are mounted means for displacing the supporting bars in the longitudinal direction of same. These means, expediently, are longitudinal rollers. The hinge elements may be either flexible hinge elements consisting, for example, of band-type or strip-type elements, but they may also be rigid elements. In the preferred version, respectively two hinge elements are mounted at a distance from one another on a supporting bar, and encompass the transverse bar with a respective hinge eyelet, and they additionally have a further eyelet for encompassing the axle of two longitudinal rollers.

The hinge elements may also have a further, additional, eyelet, through which there extends a handle. In this case, the positions of the axle for the longitudinal rollers and of the handle may optionally be interchanged, i.e., the eyelets provided in addition to the hinge eyelet for the transverse bar may optionally be used either for the axle of the longitudinal rollers or for a handle.

The holding pouch, denoted in general by 1, is formed by a U-shaped folding of the web 2, which is made from a flexible woven material. At the upper ends, the web is likewise folded over, to form small retaining loops 3, and sewn along the seam 4 to form these retaining loops 3. The seam 4 extends in the longitudinal direction of the holding pouch 1, this being the X direction in this case. The end edges of the web 2 constitute the ends of the holding pouch 1, and are closed by U-shaped inserts 5 in such a way that the web 2, folded as described, constitutes an open holding pouch 1.

Two supporting bars 6, arranged in parallel to one another, of a pair of supporting bars are inserted through the small retaining loops 3 which extend in the longitudinal direction of the holding pouch 1. The length of the supporting bars 6 is somewhat greater than the length of the holding pouch 1. These supporting bars 6 constitute part of the suspending device, denoted in general by 1, which is situated at the upper end of the pouch 1 and carries the pouch. Each supporting bar 6 is connected to the upper end of the pouch 1 in the manner described above (inserted through the retaining loop).

In the case of the version of FIGS. 1 and 2, the front and rear ends of the support bars 6 extending in the X direction (longitudinal direction of the carrying pouch 1) are provided with slide hooks 8, which are downwardly open. These are the means for displaceably guiding the holding pouch 1 in the transverse direction, i.e. in the direction Y.

In the case of the other version according to FIGS. 3 and 4, the means 9 for displaceably guiding the holding pouch 1 in this one direction Y are transverse rollers 9, which are rotatably arranged at the end regions of the supporting bars 6. The axes of rotation of these transverse rollers 9 run in the longitudinal direction of the supporting bars 6, or in the X direction.

The suspending device 7 also includes the transverse bars 10, which are arranged in the end regions of the supporting bars 6 and which are aligned perpendicularly to the longitudinal extent X of the supporting bars 6. Longitudinal rollers 11 are rotatably arranged at the end regions of these transverse bars 10. These rollers are called longitudinal rollers 11, because they permit a displacement of the transport device, of all versions represented here in the drawings, in the longitudinal direction of the holding pouch 1, i.e. in the direction X. The transverse bars 10 arranged in parallel to one another define a fixed distance between the two supporting bars 6.

Consideration of FIGS. 1 and 2, on the one hand, and FIGS. 3 and 4, on the other hand, clearly shows the difference between the two versions of the transport device respectively shown therein. In the case of the first version according to FIGS. 1 and 2, the displacement motion of the holding pouch 1 in the Y direction, i.e. in the so-called transverse direction in this case, is effected by means of bars, not shown, on which the downwardly open slide hooks 8 are suspended and over which the suspending device 7 can be displaced by sliding. This transport device of the first version can be converted to a rail system and moved away by insertion into, for example, C-shaped rails. The latter movement in the longitudinal direction, i.e. in the so-called X direction, is effected through the longitudinal rollers 11, whose axes of rotation end in the transverse bars 10.

In the case of the second version, the longitudinal rollers 11 are again also used for the displacement in the X direction; here, however, the transverse rollers 9 are used for displacement in the transverse direction, the direction Y.

The new transport device according to the invention enables piece goods transported in the holding pouches 1 to be successfully transferred, in a first rail direction, delivery direction (X), from a lorry into an intermediate frame or production-side further transport system and transported away to the Y direction, for example a discharge direction, and vice versa.

Further, different versions of a transport device according to the invention, which are of particularly simple design, are represented in FIGS. 5 to 10. The entire suspending device consists of only a single supporting bar 6 which, for reasons of simplicity, is represented as a bar which has a circular cross-section and is cut off at its ends, as clearly evident in FIG. 5. If one looks again towards the Y direction, one sees the reduced representation of FIG. 6. Shown on the right side of the figure is the cut-off supporting bar 6, which rests and is guided only on the rail 13, as a retaining means. Obviously, in the case of each version, the supporting bar 6 can be cut-off at both ends, as in the representation according to FIG. 5. Alternatively, however, a mushroom-shaped enlargement 14, for example, could be provided at one or both ends of the supporting bar 6, in order to prevent the supporting bar 6, with the suspended holding pouch 1, from tipping and falling out. It can be seen that the at least one supporting bar 6 is designed to be displaceably guided at its ends or, alternatively, has special means that have already been described above, for example the mushroom-shaped enlargement 14.

Provided in the retaining loop 3 at the top of the holding pouch 1 is a hole 15, through which there projects a pin 16, on the top of which there is attached the ball 12 as an enlargement.

This ball 12 is provided as a single enlargement in the longitudinal centre of the supporting bar 6. However, it is also possible to envisage another version, according to FIG. 9, in which two balls 12 are provided at a distance from one another on the supporting bar 6, in order to prevent tipping of the holding pouch 1. The one ball 12 or, also, the two balls 12, in the case of the one or the other version, runs or run, respectively, in a box rail 17, which is represented only in FIGS. 7 to 9, but whose function is simple and obvious.

As in the case of the version with the two supporting bars 6, all displacement advantages of the type described above are also obtained for the simplified version with only the one supporting bar.

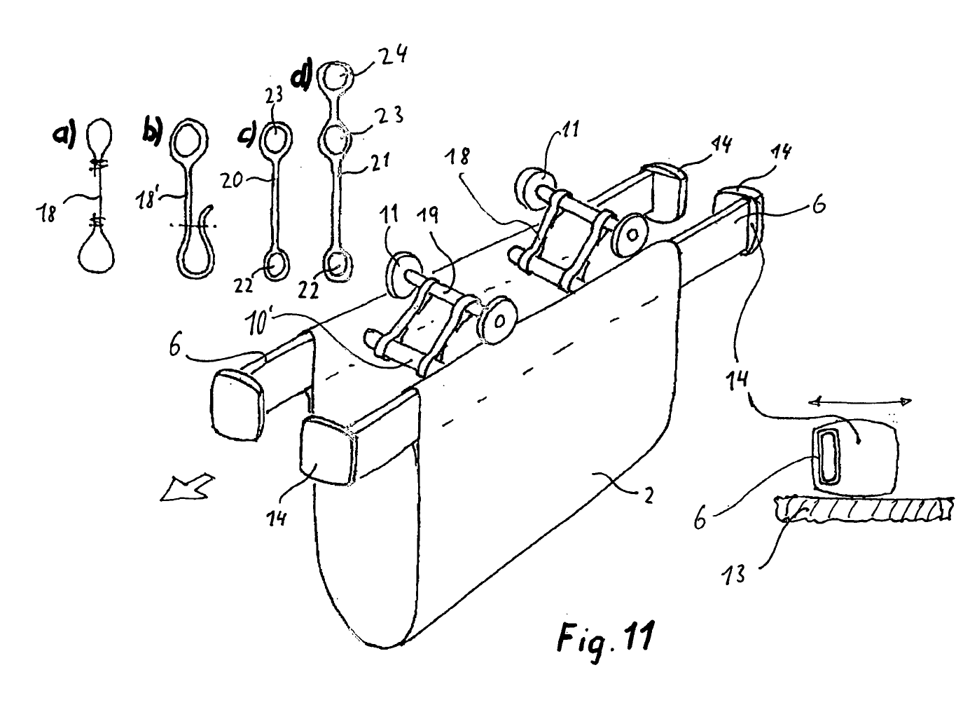

FIG. 11 shows a further version of the invention, in which two parallel supporting bars 6, between which there extends a U-shaped pouch, are joined together by two transverse bars 10′. The transverse bar 10′, in turn, is encompassed by respectively two hinge elements 18 which are provided at a distance from one another and which, in this case, are realized as robust bands having loop-and-hoop closures, the bands being respectively placed in the form of an eyelet around the transfer bar 10′ and, in turn, forming, at their free end, an eyelet through which there is guided the axle 19 of two longitudinal rollers 11. The two longitudinal rollers 11 extend somewhat over the supporting bars 6 or have a somewhat greater distance from one another.

Provided at the ends of the supporting bars 6 are respective mushroom-shaped enlargements 14 which, in this case, are essentially realized as flat head-plates provided on the ends of the supporting bars 6. As shown by a detailed representation at bottom right in FIG. 11, these head-plates lie on rails 13 which may be provided, for example, in the form of an L-shaped or U-shaped profile, in order to prevent the enlargements 14 from slipping off the rails 13. As may easily be envisaged, an entire series of the U-shaped pouches represented in FIG. 11 may be arranged in succession on two rails 13 arranged in parallel to one another (the distance between which corresponds approximately to the length of the supporting bars 6), and thus mounted in, for example, a frame or a container which can be transported on a lorry. For the purpose of unloading, these pouches are then moved in succession to the free end of the rails, a user being able to grip the pouches by the axles 19, which serve as handles, and to suspend them in a further rail pair which runs perpendicularly to the rails 13 and in parallel to the carrying pouches 6 at a distance corresponding to the length of the axle 19 of the longitudinal rollers 11, so that the longitudinal rollers 11 are guided in parallel in these rails. These rails preferably have a J-shaped or C-shaped cross-section, so that the longitudinal rollers 11 are securely guided therein. In this way, one such unit after another is pushed into the rails for the longitudinal rollers 11, these rails also being able to be inclined, so that the pouches move forward automatically. The mushroom-shaped enlargements 14 in this case also act as a buffer when a succeeding pouch strikes against a preceding pouch.

Various forms of the hinge elements 18, 18′, 20 and 21 are represented in the sub-figures a-d of FIG. 11. In the case of FIG. 11a, the hinge element 18 is, for example, a simple loop-and-hoop band or, also, another band having at its ends two eyelets which are passed around the supporting bars 10 and the axle 19 respectively, and are sewn, as indicated in the figure. In the case of FIG. 11b, one of the eyelets is already solidly integrated into the band 18′, and the band 18′ also has a greater wall thickness and is more rigid, being composed, for example, of a semi-rigid plastic material, similar in consistency to a leather band.

FIG. 11c shows a substantially rigid hinge element 20, having two eyelets 22, 23, of which one eyelet 22 encompasses the transverse bar 10′, while the other eyelet 23 encompasses the axle 19 of the two longitudinal rollers 11.

FIG. 11d, finally, shows a further rigid hinge element 21 which, like the element 20, has two eyelets 22, 23, but which additionally has a further eyelet 24 through which there may also extend a further transverse bar, which serves as a handle when a corresponding pouch is removed from the rails 13 and inserted into the J-shaped or C-shaped rails for the rollers 11. The additional handles have the advantage that the hands of the user do not come into contact with the sometimes sharp-edged ends of the rails, since the latter are situated relatively close to one another.

It is understood, however, that the eyelet 23 could also just as well receive the handle, while the axle 19 would extend, for example, through the eyelets 24.

### LIST OF REFERENCES

1 Holding pouch
2 Web of flexible material
3 Retaining loops
4 Seam
5 U-shaped inserts
6 Supporting bars
7 Suspending device
8 Slide hooks
9 Transverse rollers
10 Transverse bars
11 Longitudinal rollers
12 Ball as enlargement
13 Rail as retaining means
14 Enlargement
15 Hole
16 Pin
17 Box rail

What is claimed is:

1-22. (canceled)

23. A device for at least one of transporting and storing piece goods, said device comprising a foldable web (2), which is made of flexible material and which is folded while forming at least one essentially U-shaped holding pouch (1), in which the piece good can be held, and comprising a suspending device (7), which is situated at the upper end of the pouch (1) and which has at least one supporting bar (6), which can be connected to the upper end of the pouch (1), extends away in a longitudinal direction (X) over the length of the pouch (1), which supporting bar having ends mounted in retaining means fastened to a frame, wherein the at least one supporting bar (6) is provided with means for displaceably guiding the holding pouch (1) in at least two different directions (X, Y), at least a portion of these means being provided at the ends of the supporting bar (6).

24. A device according to claim 23, wherein in the region of the ends of the at least one supporting bar (6), means (8; 9, 11; 12; 14) are provided for displaceably guiding the holding pouch (1) in at least two different directions.

25. A device according to claim 23, wherein the suspending device (7) has at least two supporting bars (6).

26. A device according to claim 23, wherein the means for displacing the holding pouch (1) in at least two different directions is of such design that the holding pouch (1) can be displaced in two displacement directions (X, Y) which are perpendicular to each other.

27. A device according to claim 25, wherein the distance between the two supporting bars (6) is fixed, and determined by a respective transverse bar (10) arranged in the region of the bar end.

28. A device according to claim 23, wherein the means (8) for displaceably guiding the holding pouch (1) in a direction (Y) have downwardly open slide hooks (8) mounted at the end regions of the supporting bars (6).

29. A device according to claim 24, wherein the means (8) for displaceably guiding the holding pouch (1) in a direction (X) have downwardly open slide hooks (8) at the end regions of the supporting bars (6).

30. A device according to claim 24, wherein the means (11) for displaceably guiding the holding pouch (1) in a direction (X) have longitudinal rollers (11) rotatably arranged at the end regions of the transverse bars (10).

31. A device according to claim 24, wherein the means (9) for displaceably guiding the holding pouch (1) in a direction (Y) have transverse rollers (9) rotatably arranged at the end regions of the supporting bars (6).

32. A device according to claim 24, wherein the means (8) for displaceably guiding the holding pouch (1) in both directions (X, Y) have downwardly open slide hooks (8).

33. A device according to claim 24, wherein the means (8, 11) for displaceably guiding the holding pouch (1) in both directions (X, Y) have rollers (9, 11) rotatably arranged on the supporting bars (6) and on the transverse bars (10).

34. A device according to claim 22, wherein the ends of the supporting bar (6) are supported on or in a rail (13, 17), as a retaining means.

35. A device according to claim 23, wherein the means (8; 9, 11; 12; 14) for displaceably guiding the holding pouch (1) in a direction has slide hooks (8), rollers (9, 11), or enlargements (12, 14).

36. A device according to claim 23, wherein there is provided on top of the supporting bar (6) at least one enlargement (12) as means for displaceably guiding the holding pouch (1) in at least one direction (X or Y).

37. A device according to claim 24, wherein the two supporting bars (6) are connected to one another by at least one transverse bar (10′) arranged at a distance from the ends of the supporting bars.

38. A device according to claim 37 wherein there is provided on the transverse bar (10′) at least one hinge element (18, 18′, 20, 21), which extends transversely away from the transverse bar (10′), and which is rotatably mobile about the transverse bar (10′) and has, in a region at a distance from the transverse bar (10′), at least one eyelet (23) for receiving an axle on which are mounted means for displacing the holding pouch in the longitudinal direction of the supporting bars (6).

39. A device according to claim 38 wherein the means for moving the holding pouches (1) in the longitudinal direction are longitudinal rollers (11).

40. A device according to claim 39 wherein at least one hinge element (18, 18′) is composed of a flexible strip material.

41. A device according to claim 39 wherein the hinge element is composed of a semi-rigid or rigid material.

42. A device according to claim 38 wherein the hinge element has at least two eyelets (22, 23), of which one is provided for receiving the transverse bar (10′) and another is provided for receiving the axle (19).

43. A device according to claim 42 wherein the hinge element (21) has a third eyelet (24) which is at a distance from the transverse bar (10′) and which is provided for receiving a handle.

44. A device according to claim 38 wherein respectively two hinge elements (18, 18′, 20, 21), parallel to and at a distance from one another, are provided on a transverse bar (10′).
